(19) United States
(12) Patent Application Publication
(10) Pub. No.: US 2026/0237300 A1
(43) Pub. Date: Aug. 13, 2026

(54) DEVICE, SYSTEM, AND METHOD OF DETECTING, ANALYZING, VERIFYING, REPORTING, AND RESPONDING TO VEHICLE CRASHES AND OTHER EMERGENCIES

(71) Applicant: Zubi Technologies Limited, Lagos (NG)

(72) Inventors: Nzube John Etonye, West Covina, CA (US); Johnson I. Moyebi, Mowe (NG)

(73) Assignee: Zubi Technologies Limited, Lagos (NG)

(21) Appl. No.: 19/179,056

(22) Filed: Apr. 15, 2025

Related U.S. Application Data
(60) Provisional application No. 63/757,028, filed on Feb. 11, 2025.

(51) Int. Cl. G08G 1/16; B60K 35/25; B60K 35/26; B60K 35/28; H04W 4/90

(52) U.S. Cl. CPC G08G 1/161; B60K 35/25; B60K 35/26; B60K 35/28; H04W 4/90

(57) ABSTRACT

A device, system, and method of detecting, analyzing, verifying, reporting, and responding to vehicle crashes and other emergencies is disclosed. This invention goes beyond collision detection, as it can also detect vehicle submersion and somersault/flipping, while also being able to share real-time data with Insurance firms and emergency responders via a secure server.

### CROSS REFERENCE TO RELATED APPLICATION

This application claims the benefit of priority of U.S. provisional application No. 63/757,028, filed Feb. 11, 2025, the contents of which are herein incorporated by reference.

### BACKGROUND OF THE INVENTION

In the current state of the art, vehicle safety has become a significant concern, particularly in light of the increasing number of accidents on the roads. While various technologies have been developed to enhance road safety, there remains a pressing need for more effective solutions that can quickly and accurately detect crashes and facilitate emergency responses.

One common issue with existing crash detection systems is their limited scope, often only detecting collisions or rollover events. However, this narrow focus overlooks other critical scenarios, such as water submersion incidents, which can result in devastating consequences if not addressed promptly. Moreover, most current solutions rely on manual reporting mechanisms, which can lead to delayed and inaccurate information being provided to emergency responders.

Furthermore, the lack of real-time data transmission capabilities means that critical information is often unavailable or delayed, hindering the effectiveness of emergency responses. This deficiency is particularly problematic in situations where every second counts, such as when a driver is stranded in a submerged vehicle or requires urgent medical attention.

The objectives of the present invention are to provide a comprehensive and intelligent crash detection system that can accurately identify various types of auto crashes, including collisions, somersaults, water submersion incidents, and SOS emergencies. The system should be able to transmit real-time data to a centralized control station, enabling swift and informed emergency responses.

Therefore, the need exists for a cutting-edge IoT device that can seamlessly integrate advanced sensor technology, robust server integration, and user-friendly interfaces to enhance vehicle safety, improve emergency response efficiency, and reduce fraudulent insurance claims.

In several cases of auto crashes and other emergencies, there is a vast gap between the time of occurrence and when help is being discharged, resulting in loss of lives or permanent damages. Little or no access to crash records by insurance firms often leads to false insurance claims.

Conventional crash detection systems do not have dedicated somersault and water submersion sensors for accurate and reliable detection. The existing systems use only live calls to verify crash emergencies.

This invention goes beyond collision detection, as it can also detect vehicle submersion and somersault/flipping, and the invention is able to share real-time data with Insurance firm and emergency responders via a secure server.

### SUMMARY OF THE INVENTION

The vehicle-embedded device of the present invention solves the issue of delayed emergency response by using a combination of sensors to detect various types of auto crashes, including collisions, somersaults, water submersion incidents, and SOS emergencies. Upon detection, the device sends real-time data, including the type of accident, impact area on the vehicle and the vehicle's geolocation, to a centralized control station (secured server) via the cellular network.

These and other features, aspects and advantages of the present invention will become better understood with reference to the following drawings, description and claims.

### BRIEF DESCRIPTION OF THE DRAWINGS

FIG. 1A is a perspective view of certain primary components of a preferred embodiment of the present invention;

FIG. 1B is a perspective view of a main controller board in accordance with a preferred embodiment of the present invention;

FIG. 1C is a front perspective view of an impact sensor in accordance with a preferred embodiment of the present invention;

FIG. 1D is a front perspective view of a button controller in accordance with a preferred embodiment of the present invention;

FIG. 2A is a partial flowchart depicting aspects of a preferred embodiment of the present invention;

FIG. 2B is a partial flowchart depicting aspects of a preferred embodiment of the present invention;

FIG. 3 is a partial flowchart depicting aspects of a preferred embodiment of the present invention;

FIG. 4A is a front perspective view of an impact sensor in accordance with a preferred embodiment of the present invention;

FIG. 4B is a side perspective view of an impact sensor in accordance with a preferred embodiment of the present invention;

FIG. 4C is a bottom perspective view of an impact sensor in accordance with a preferred embodiment of the present invention;

FIG. 5A is a bottom perspective view of a button controller in accordance with a preferred embodiment of the present invention; and

FIG. 5B is a side perspective view of a button controller in accordance with a preferred embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As stated above, in several cases of auto crashes and other emergencies, there is a vast gap between the time of occurrence and when help is being discharged, resulting in loss of lives or permanent damages. Little or no access to crash records by insurance firms often leads to false insurance claims. The invention claimed here solves these and other problems with conventional systems and methods.

The vehicle-embedded device of the present invention solves the issue of delayed emergency response by using a combination of sensors to detect various types of auto crashes, including collisions, somersaults, water submersion incidents, and SOS emergencies. Upon detection, the device sends real-time data, including the type of accident, impact area on the vehicle and the vehicle's geolocation, to a centralized control station (secured server) via the cellular network.

The system verifies the request via AI and live calls and promptly dispatches appropriate emergency responders to the scene. This minimizes the time between accident occurrence and the arrival of help. The crash data being sent to a secure server will ensure insurance firms receive accurate and real-time information to validate claims.

The Emergency Vehicle-Crash Alert Device (EVADE) is a cutting-edge IoT device designed to enhance vehicle safety and emergency response efficiency. EVADE detects three types of crashes: collisions (fatal and non-fatal), somersaults, and water submersion. Upon detection, it provides critical information, including the exact location, date, time, nature, and type of the crash. The device is equipped with a multifunctional button, enabling drivers to request help during emergencies (SOS) or cancel non-fatal collision alerts.

EVADE's primary goals are to ensure prompt emergency response, improve the accuracy of accident reporting, and reduce fraudulent insurance claims. With advanced sensor technology, seamless server integration, and a user-friendly dashboard, EVADE sets a new standard for vehicle safety and insurance verification.

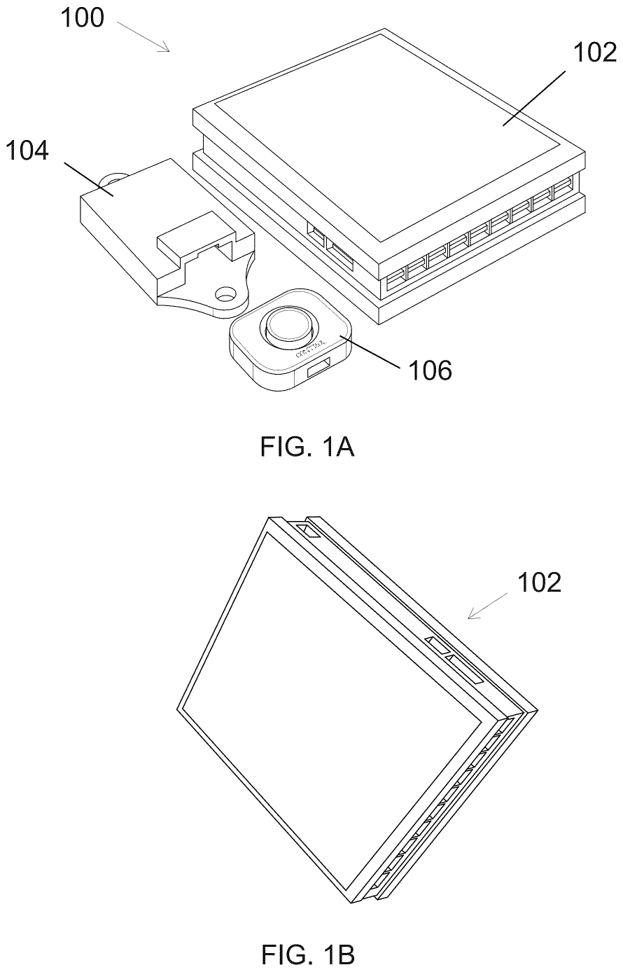

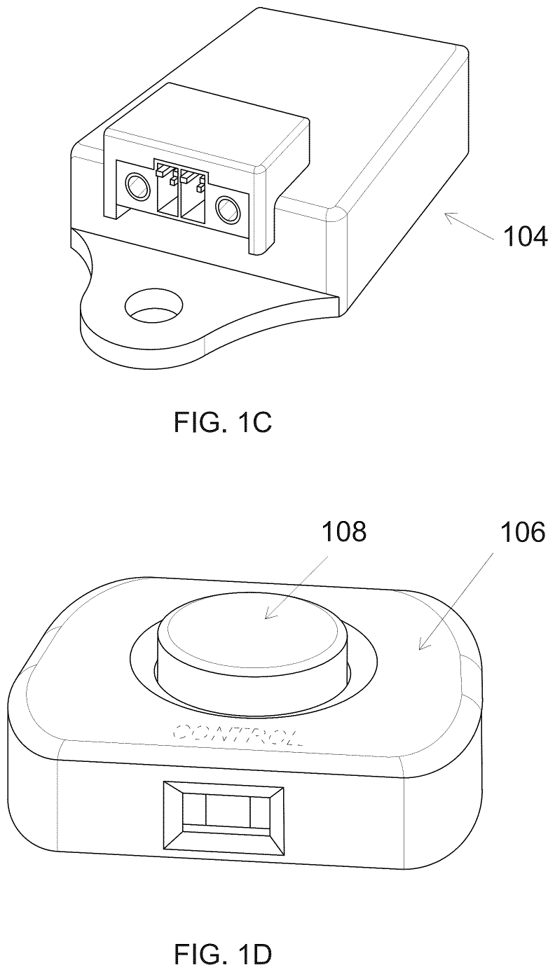

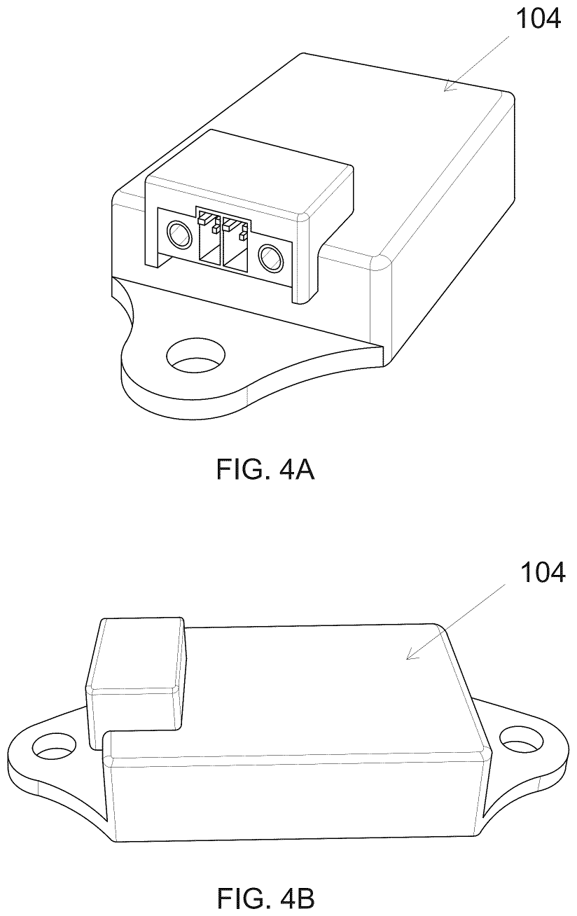

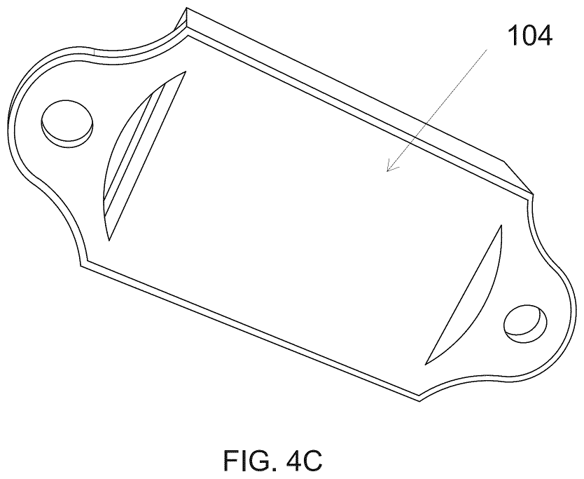

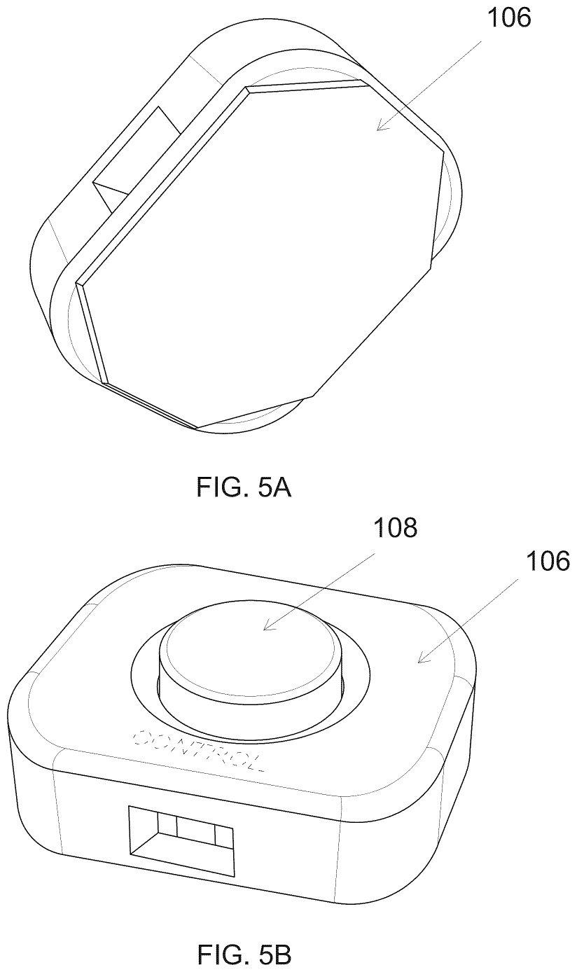

In a preferred embodiment, and as seen by way of example in FIGS. 1-5, the present invention comprises the following:
1. Accident Detection: Detects collisions (both fatal and non-fatal), somersaults, and water submersion incidents.
2. Sensors (104): Equipped with multiple sensors strategically installed throughout the vehicle to detect crashes accurately.
3. Impact Localization: Identifies where a collision occurs within the vehicle and sends this information to the server.
4. Multipurpose Button (108):
   a. SOS Functionality: When pressed for 3-5 seconds, it sends a high-priority help request to the server during distress situations.
   b. Interrupt Functionality: When pressed briefly within 15 seconds of a non-fatal collision alert, it nullifies the alert before it is sent to the server.
5. Steering Feedback: Vibrates the steering wheel to notify the driver of a detected collision and a successful communication to the server.
6. Crash Data Transmission: Sends crash-related data (e.g., location, time, type, and severity) or help requests to the server for emergency response when triggered by the system or driver action.
7. Device Status Monitoring: Continuously transmits real-time vehicle location, date, and time (“heartbeats”) to the server, enabling continuous monitoring of the device's status and activeness.
8. Automated Calls: Automatically receives and answers calls from registered agencies during high-priority notifications.
9. Web Dashboard: Features a dashboard for detailed monitoring, reporting, and management of each device, including real-time crash data.
10. Mobile Notification: Able to receive crash and other emergencies notifications via mobile app, email and SMS.
11. Access for Insurance, Government Agencies, and other Third Parties: Provide secure, real-time crash data to insurance firms, government agencies, and other third parties for claim verification, fraud combat, emergency services, government regulatory policies, and other use cases.

### Specifications

1. Communication:
   Supports 2G, 3G, and 4G networks.
   Uses a SIM card with a unique phone number.
2. Device Identification:
   Contains a unique IMEI and device ID for secure identification and tracking.
3. Audio Features:
   Equipped with an inbuilt microphone and speaker.
   Supports connection to an external speaker.
4. Power Supply:
   Powered externally by the vehicle's battery.
   Includes an inbuilt rechargeable battery for backup operation during power failure.
5. Server Integration:
   Seamlessly connects with a secure server for data storage and processing.
   Provides data access via a web-based dashboard.

### FUNCTIONALITIES

### Components of EVADE

1. Main Controller Board (102):
   Houses the microcontroller, MPU6050 (somersault sensor), 4G GNSS cellular module, power supply unit, and audio circuitry.
   Facilitates communication with sensors (104), button controller (106), and the server.
   Amplifies audio outputs for cellular communication.
2. External Sensors (104):
   Impact Sensors: Installed on the doors, front, back bumpers, and other strategic points to detect impacts
   Water Sensor: Detects submersion or flooding situations.
3. Button Controller (106):
   Contains a multipurpose SOS/Interrupt Button (108) for driver input.
   Includes a vibrator to alert the driver following collision detection and successful server communication.
4. Power Source:
   Draws power from the vehicle's voltage distribution board.
   Equipped with an integrated rechargeable battery to ensure backup functionality during external power failure.

### Functions

1. Main Controller Board:
   Houses the microcontroller, MPU6050 (somersault sensor), 4G GNSS cellular module, power supply unit, and audio circuitry.
   Facilitates communication with sensors, button controller, and the server.
   Amplifies audio outputs for cellular communication.
2. External Sensors:
   Impact Sensors: Installed on the doors, front, back bumpers, and other strategic points to detect impacts
   Water Sensor: Detects submersion or flooding situations.
3. Button Controller:
   Acts as an interrupt button to nullify non-fatal collision alerts.
   Functions as an SOS button to request emergency assistance.
4. Power Source:
   Draws power from the vehicle's voltage distribution board.
   Equipped with an integrated rechargeable battery to ensure backup functionality during external power failure.

### Functions

1. Main Controller Board:
   Manages input signals from sensors and keypad controllers via wired connections.
   Communicates with the server through a wireless 4G cellular connection.
   Uses the MPU6050 sensor to detect somersaults based on high-axis variations.
   Amplifies audio for alerts or automated calls.
2. External Sensors:
   Collision Sensors: Detect impacts at specific vehicle locations.
   Water Sensor: Identifies drowning scenarios.
3. Button Controller:
   Multipurpose Button:
      Acts as an interrupt button to nullify non-fatal collision alerts.
      Functions as an SOS button to request emergency assistance.
   Vibrator: Alerts the driver to act following a collision detection.
4. System Initialization:
   Initializes all components (sensors, 4G module, and actuators) upon powering on.
5. OTA (Over-The-Air Updates):
   Supports wireless firmware updates for system enhancements and bug fixes.
6. Heartbeat and Communication:
Sends a heartbeat signal every 15 minutes to the server to confirm device activeness.
   Successful communication triggers vibration feedback on the button controller.
7. Dashboard and Monitoring:
   Super Admin: Oversees dashboard operations, monitors agents, and ensures smooth system functionality.
   Agents:
      Manage device owner requests automatically assigned by the system.
      Must accept assigned requests within one minute, or the system reassigns them.
   Responders: Assigned by agents to handle high-priority emergency requests (e.g., firefighters, medical teams, security teams etc.).
8. Responder Actions:
   Respond promptly to high-priority alerts relayed by the system through agents.

### INSTALLATION PROCEDURE

1. Main Component Placement:
   Install the EVADE main controller unit beneath the vehicle's dashboard via a double-sided tape for central access.
2. Button Controller Installation:
   Securely mount the button controller on the vehicle's steering wheel via a double-sided tape for easy driver access.
3. Sensor Installation:
   Position impact sensors on the doors, front, and back bumpers using bolts and nuts.
   Install the water sensor at the vehicle's lowest point to detect submersion.
4. Power Connection:
   Connect the EVADE main device to the vehicle's voltage distribution board via wire to the “POWER” labelled connector on the EVADE device.
5. Wiring and Connectivity:
   Establish wired connections between the main controller, button controller, and sensors.
   Verify the cellular module's network connection for communication with the server.
   Connect the impact sensor to any of the connectors labelled “A”-“J” on the main device depending on the point to install the sensor
   Connect the button control to the connector labelled “INTERFACE” on the main device
   Connect the water sensors to the connector labelled “WAT-A” & “WAT-B” on the main device
6. Testing and Calibration:
   Calibrate all sensors to ensure accurate detection of collisions, somersaults, and water submersion.
   Test the SOS/Interrupt button, vibration feedback, and server Communication.

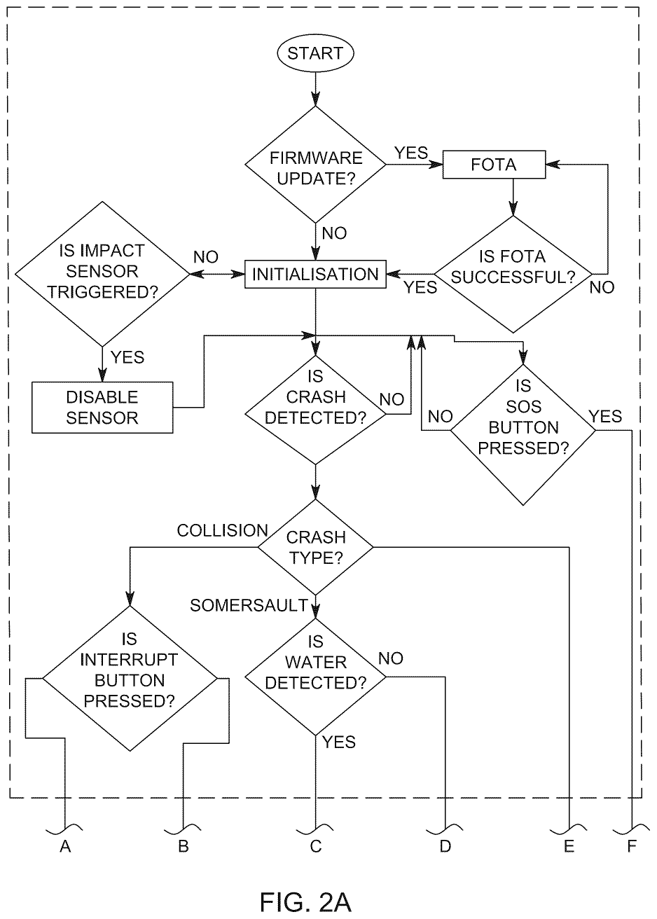

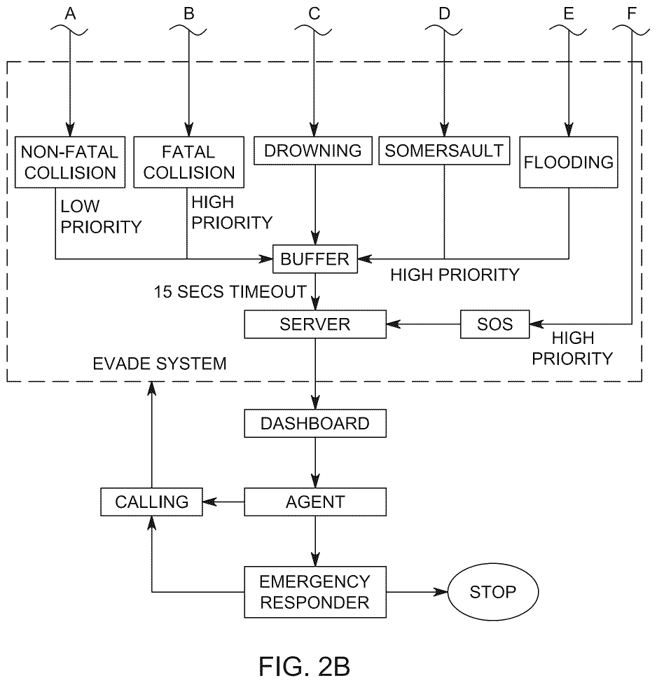

FIG. 2A illustrates a flowchart depicting the operational sequence of the present invention, specifically highlighting the various conditions and triggers that govern the detection and reporting of vehicular crashes. This diagram provides a visual representation of the complex interactions between the device's sensors, firmware updates, and user inputs.

The flowchart begins by initializing the system, which involves checking for any pending firmware update (FOTA) and ensuring its successful installation. Subsequently, the device enters an idle state, monitoring environmental conditions and waiting for potential crash events to occur.

When a crash is detected, the system evaluates the type of event, distinguishing between collisions, somersaults, water submersion incidents, and SOS emergencies. This information is obtained through the combination of sensors strategically installed throughout the vehicle, which provide real-time data on the nature and severity of the incident.

In response to a crash detection, the device may trigger various actions, including the activation of the impact sensor, notification of the driver via steering wheel feedback, and transmission of real-time crash data to the centralized control station. The user is also afforded opportunities to intervene, such as canceling non-fatal collision alerts or requesting help during SOS emergencies.

Throughout this process, the system continuously monitors its status and activeness, transmitting “heartbeats” to the server to ensure uninterrupted communication. This ensures that critical information is always available for emergency responders and insurance companies alike, enabling swift and informed decisions in response to vehicular accidents.

By visualizing these interactions, FIG. 2A provides a valuable tool for understanding the intricate mechanisms underlying the present invention's crash detection and reporting capabilities.

FIG. 2B illustrates the flowchart for emergency response scenarios in the EVADE system. This diagram provides a visual representation of how the system categorizes different types of crashes and events based on their priority levels, triggering various responses from the server and emergency responders. The figure highlights the role of the SOS button, enabling drivers to request help during distress situations. By depicting these interactions, FIG. 2B offers valuable insights into the EVADE system's emergency response capabilities, showcasing its ability to prioritize critical situations and ensure swift communication with relevant parties.

Depending on the type of crash or event, the system enters either a “LOW PRIORITY” or “HIGH PRIORITY” state. In the former case, the system may send a non-emergency notification to the server and dashboard, while in the latter case, it triggers an emergency response by alerting the server and emergency responders.

The diagram also highlights the role of the SOS button, which allows drivers to request help during distress situations. If the driver presses the SOS button for 15 seconds or more, the system will trigger a high-priority emergency response, sending notifications to the server and emergency responders.

Throughout this process, FIG. 2B provides a visual representation of how the EVADE system responds to various emergency scenarios, prioritizing critical situations and ensuring swift communication with emergency responders and other relevant parties.

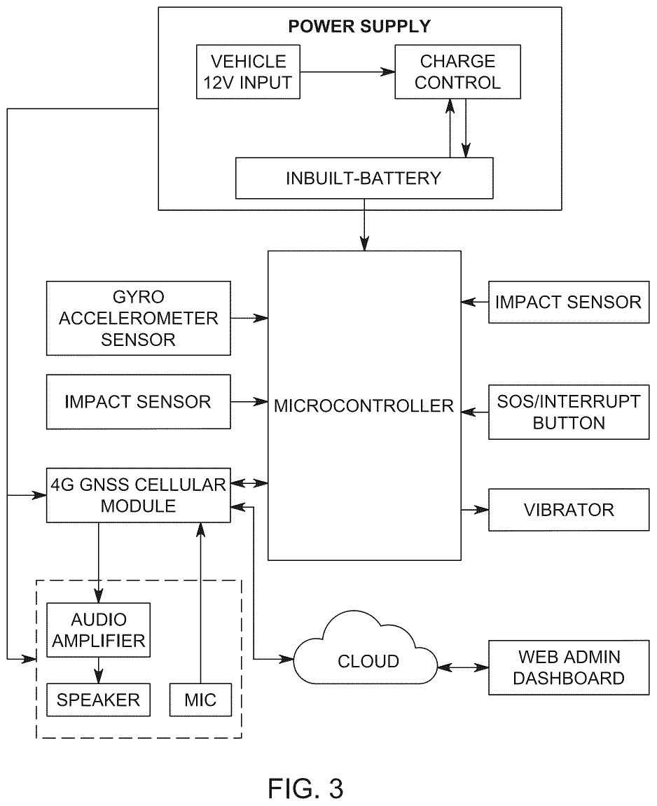

FIG. 3 illustrates a block diagram of the EVADE system's hardware components and communication modules. This figure provides a detailed representation of the device's power supply, sensing and measurement subsystems, communication module, audio feedback mechanism, SOS/Interrupt button, microcontroller, and other key components that enable its crash detection and reporting capabilities. The diagram shows how these components work together to provide real-time data transmission, emergency response notifications, and seamless integration with the cloud/web admin dashboard.

The diagram begins by highlighting the power supply system, which includes an inbuilt battery, 12V input, and charge control circuitry. This ensures a stable power source for the device's components. Next, it illustrates the sensing and measurement subsystems, featuring a gyro, accelerometer, and impact sensor. These sensors work together to detect various types of crashes, including collisions, somersaults, water submersion incidents, and SOS emergencies.

The figure also shows the communication module, which includes a 4G GNSS (Global Navigation Satellite System) cellular module for transmitting real-time crash data to the centralized control station. Additionally, it highlights the audio amplifier, speaker, and microphone components responsible for providing auditory feedback to drivers during emergency situations.

The SOS/Interrupt button is depicted as a key input mechanism that allows drivers to request help or cancel non-fatal collision alerts.

Furthermore, FIG. 3 shows the microcontroller, which serves as the central processing unit (CPU) of the device. This component is responsible for integrating data from various sensors and modules, processing crash events, and transmitting relevant information to the cloud/web admin dashboard.

The claimed invention differs from what currently exists. This invention offers multi-layered verification of accidents and additional detection capabilities for somersaults and water submersions. This invention integrates an interrupt button to nullify collision detection, an AI-based verification process, and a call-back feature from the centralized control station to confirm the nature of the accident. The device is compatible with existing airbag sensors.

As discussed herein, and as seen by way of example in FIGS. 1-5 hereto, in a preferred embodiment the present invention comprises the following primary components:
Microcontroller:
   Manages data processing and communication
4G GNSS Module:
   Provides GNSS-based location tracking and cellular communication
SIM card:
   Facilitates network communication
Gyroscope sensor:
   Detects somersaults and flipping. Water sensor: Detects vehicle submersion (drowning and flooding)
Vibration sensor:
   Detects collision impacts
Vibration motor:
   Provides feedback to the driver after impact detection
Limit switch:
   Used in making the proprietary impact sensors
LEDs:
   Provides system status notifications
Connectors:
   Various pins and connectors for wiring and communication between components
Audio Amplifier, Speaker, and Microphone:
   Enable two-way communication between the centralized control station and the vehicle.
Tact buttons:
   For SOS and Interrupt functionalities.
Power Components:
   Includes batteries, voltage regulators, resistors, and capacitors to maintain system operation.
Plastic Molded Cases:
   For housing the components.
FR-4 Printed Circuit Board (PCB):
   Provide electrical connections between components.
FPC PCB:
   For flexible control interface. Web Dashboard: For centralized control station monitoring, agent assignment, and emergency handling.

### Relationship Between The Components

The components of this invention work in synergy to detect auto crashes and other emergencies, communicate with the secured server, and trigger emergency response. Sensors installed throughout the vehicle detect accidents, and the main control unit processes these signals. The device communicates with the secure server via the 4G GNSS module, while the SOS and interrupt buttons allow manual intervention by the driver. The audio components enable voice communication with emergency responders, while the web dashboard allows centralized control station agents to manage and track accidents and other emergency reports.

### How the Invention Works

This invention is powered by the vehicle's battery and connected to various sensors (collision, gyroscope, vibration, motion, speed breaker, water sensors, etc.). When a collision occurs, the impact sensors send a signal to the main control unit, which vibrates the steering wheel as feedback for the driver. If the accident is non-fatal, the driver can press the interrupt button within 15 seconds to cancel the emergency alert, but it automatically stores and saves the crash data to the secure server by the control unit. If the crash is critical or the button is not pressed, the control unit sends the crash data to the centralized control station (secured server), including the geolocation, type, and nature of the crash. The centralized control station receives the data on a web dashboard and follows a three-step verification process: automated AI call, live call, and manual intervention, ensuring an accurate assessment of the situation. The appropriate emergency response is dispatched based on this verification. For somersaults and water submersion, similar processes are followed with dedicated sensors detecting these specific events and reporting them to the centralized control station. If the driver presses the SOS button, the system initiates the same process for non-detected emergencies. The device has an inbuilt backup battery, which ensures continuous operation of the sensors and control unit, even when the vehicle's main power supply is compromised or turned off. This battery allows the system to function during an emergency, providing critical crash data and ensuring timely communication with the centralized control station.

### Necessary Elements

Microcontroller for processing.
4G GNSS module for communication and location tracking.
Impact sensors for collision detection.
Gyroscope sensor for somersault detection.
Water sensor for drowning detection.
SOS and interrupt buttons for manual intervention.
Power source connected to the vehicle's battery.
Secured server and web dashboard for detailed monitoring.

### Optional Elements

Advanced AI algorithms for predictive crash detection.
Additional vibration motors for multiple alert points.

### Potential Additions

Wearable Integration with the control unit: Allowing integration with wearable devices to detect driver or passenger injuries and health condition, further improving emergency response accuracy.

Driver Behavior Monitoring: Implementing sensors to monitor driver behavior such as speed, braking patterns, and fatigue levels, providing insights for both safety improvements and insurance risk assessments.

### How to Use the Invention

Once installed in a vehicle, this invention operates autonomously. Upon detecting an accident (collision, somersault, or submersion), the system sends a signal to the centralized control station (secured server) with the location, type, and nature of the incident.

The driver can manually intervene by pressing the interrupt button for non-fatal accidents or the SOS button for non-detected emergencies. The system handles communication with the centralized control station, initiating the verification process and ensuring that the appropriate emergency response is dispatched efficiently.

Once the system sends the crash data to the centralized control station (secure server), the web-based dashboard provides real-time access to the incident details. For agents, the dashboard displays critical information, including the accident type, severity, geolocation, and verification status (based on the AI call, live call, and manual intervention). Agents can track the progress of the emergency response, assign appropriate responders, and monitor the situation as it evolves. Additionally, insurance companies can access the real-time crash data through a secure portal on the dashboard. This enables them to immediately validate claims, assess the incident's legitimacy, and streamline the claims process, reducing fraudulent claims and expediting customer support

It should be understood, of course, that the foregoing relates to exemplary embodiments of the invention and that modifications may be made without departing from the spirit and scope of the invention as set forth in the following claims.

What is claimed is:

1. A vehicle-embedded crash detection and emergency response system, comprising:
a) one or more sensors for detecting crashes, including collisions, somersaults, and water submersion incidents;
b) a microcontroller for processing sensor data and communicating with a centralized control station via a secure communication link;
c) a power source connected to the vehicle's battery and an inbuilt battery, allowing the system to operate continuously even when the vehicle's main power supply is compromised or turned off;
d) one or more SOS/interrupt buttons for manual intervention by the driver during emergencies;
e) a secured server and web-based dashboard for real-time monitoring of crash data, geolocation, and verification status, accessible to emergency responders and insurance firms; and
f) a mobile device for notification via mobile app, email and SMS.

2. The vehicle-embedded crash detection and emergency response system of claim 1, wherein the sensors include a gyroscope sensor for detecting somersaults and flipping.

3. The vehicle-embedded crash detection and emergency response system of claim 1, wherein the sensors include a water sensor for detecting vehicle submersion.

4. The vehicle-embedded crash detection and emergency response system of claim 1, wherein the microcontroller is configured to provide audible feedback to the driver after impact detection through an audio amplifier, speaker, and microphone.

5. The vehicle-embedded crash detection and emergency response system of claim 1, the system includes a vibration motor for providing tactile feedback to the driver during emergency situations.

6. The vehicle-embedded crash detection and emergency response system of claim 1, wherein the system monitors and detect device status and sensor health in real-time.

7. The vehicle-embedded crash detection and emergency response system of claim 1, wherein the system is compatible with an existing vehicle airbag system.

8. The vehicle-embedded crash detection and emergency response system of claim 1, wherein the system is able to detect possible device tampering and issue a notification in response.

9. The vehicle-embedded crash detection and emergency response system of claim 1, wherein the secured server and web-based dashboard also include an API (Application Programming Interface) integrable with any third-party platform or system.

10. A method for detecting and responding to vehicle crashes and other emergencies, comprising:
a) detecting a crash event using one or more sensors;
b) analyzing sensor data to determine the type of crash event;
c) transmitting real-time crash data, including the type of crash event, severity, impact localization, location, and time, to a centralized control station via a secure communication link;
d) receiving and processing the transmitted crash data at the centralized control station;
e) providing emergency response services to the vehicle occupant(s), including sending alerts to emergency responders and insurance companies; and
f) updating the vehicle's status on a web-based dashboard for real-time monitoring.

11. The method of claim 9, wherein step (a) includes detecting a collision using a vibration sensor and detecting a somersault or flipping using a gyroscope sensor.

12. The method of claim 9, wherein step (e) further includes sending real-time updates to emergency responders via a secure communication link and providing insurance companies with access to the crash data through a secure portal on the web-based dashboard.

13. The method of claim 9, wherein step (f) includes updating the vehicle's status on the web-based dashboard in real-time, enabling insurance companies to verify claims and emergency responders to dispatch aid more efficiently.

14. The method of claim 9, wherein the system monitors and detect device status and sensor health in real-time.

15. The method of claim 9, wherein the system is compatible with an existing vehicle airbag system.

16. The method of claim 9, wherein the system is able to detect possible device tampering and issue a notification in response.

17. The method of claim 9, wherein the web-based dashboard also includes an API (Application Programming Interface) integrable with any third-party platform or system.
